(19) United States
(12) Patent Application Publication
(10) Pub. No.: US 2015/0000182 A1
(43) Pub. Date: Jan. 1, 2015

(54) INSECT TRAP

(71) Applicant: David Gomez, Alice, TX (US)

(72) Inventor: David Gomez, Alice, TX (US)

(21) Appl. No.: 13/932,254

(22) Filed: Jul. 1, 2013

(51) Int. Cl. A01M 1/10; A01M 1/20

(52) U.S. Cl. CPC A01M 1/106; A01M 1/2016
USPC 43/122; 43/107

(57) ABSTRACT

An insect trap for trapping insects that includes: a bottom compartment, where the bottom compartment includes a base and a rim and the base houses a bait to attract an insect; a funnel positioned above the bottom compartment, where the funnel includes an opening and a neck, where the insect flies through the opening and the neck and becomes trapped within the bottom compartment; and a lid attached to the opening of the funnel, where the lid provides a mechanism to close the opening after the insect is trapped within the bottom compartment.

### BACKGROUND OF THE INVENTION

1. Field of the Invention

The present invention relates to a container to trap insects. The container includes a lower compartment to house bait and a funnel to trap the insects within the bottom compartment.

2. Description of Related Art

During the warm weather months many individuals enjoy spending time outdoors in the warm sun. Sports, camping, grilling and picnics are just a few of the activities the people enjoy. Outdoor cooking brings food normally kept indoors outside, so with the food nuisances like insects and scavenger animals typically come as well. Bees, flies, gnats, wasps and the like within a range of the food are attracted by the smell, and narrow in immediately once the smell in encountered.

Bees are especially problematic when cooking outdoors due to strong allergic reactions experienced by those who suffer from bee sting allergies. If a person with bee allergies is stung action must be taken immediately to ensure that complications are minimized. Sometimes the reactions are so bad that serious injuries or even death may occur. For these reasons, persons with bee sting allergies often remain indoors during the summer months to prevent bee exposure.

It would be beneficial in the art to provide an insect trap that is easy to use and portable so that they may be set up when cooking outdoors. It would also be desirable in the art to provide an insect trap that closes to ensure that the insects remain within the trap until disposed of after use.

### SUMMARY OF THE INVENTION

The present invention relates to an insect trap comprising: a bottom compartment, where the bottom compartment includes a base and a rim and the base houses a bait to attract an insect; a funnel positioned above the bottom compartment, where the funnel includes an opening and a neck, where the insect flies through the opening and the neck and becomes trapped within the bottom compartment; and a lid attached to the opening of the funnel, where the lid provides a means to close the opening after the insect is trapped within the bottom compartment.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of an insect trap in accordance with an exemplary embodiment of the present invention.

### DETAILED DESCRIPTION OF THE DRAWINGS

The present invention relates to a container to trap insects. Specifically the present invention provides an insect trap to assist users to prevent insect stings and attacks when outdoors. The insect trap may trap a variety of insects including bees, wasps, flies, gnats and the like thereby preventing potentially lethal stings from occurring. The insect trap includes a double compartment design wherein the bottom compartment includes a small amount of bait and the upper compartment is shaped like a funnel as an entryway for the insects to reach the bait. Once through the conical funnel and into the bottom compartment the insects are trapped and a lid is placed on the trap for disposal. By providing an easy to use insect trap more people may enjoy the outdoors without the fear and apprehension of stinging insects.

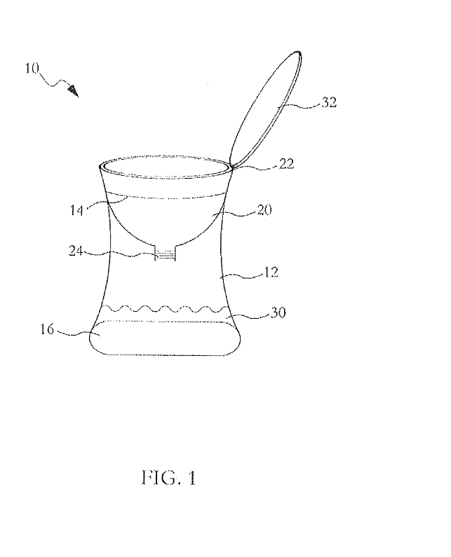

Turning now descriptively to the drawing, referring to FIG. 1, a perspective view of an insect trap 10 is shown in accordance with an exemplary embodiment of the present invention. The insect trap 10 may comprise two compartments, a bottom container 12 and a conical funnel 20. The bottom container 12 includes a rim 14 along the topmost portion and a base 14 at the lowermost portion. The bottom container 12 may comprise a generally circular cup shape, a squared shape or another geometric shape able to hold a substance. The bottom container 12 may be made from a plastic or aluminum material for a portable and lightweight design.

Within the base 16, the bottom container 12 includes bait 30. The bait 30 may be a substance that is attractive to insects. For example, the bait 30 may be sugar water, honey, soda, sugar cubes, candy or the like. The bait 30 is essentially a substance that attracts insects for feeding. The bait 30 may also include a pesticide as an active ingredient to kill any trapped insect.

The conical funnel 20 may be shaped as a hemisphere with an opening 22 at a top portion and a neck 24 at a bottom portion. The neck 24 is narrower than the opening 22 to ensure that a funnel shape is formed. The conical funnel 20 is a coordinating shape to the bottom container 12 so that when the conical funnel 20 rests against the rim 14 of the bottom container 12 the fit is snug and no gaps are present (as illustrated). The material that comprises the conical funnel 20 is the same material that comprises the bottom compartment 12.

The bottom compartment 12 and the conical funnel 20 may be made from a plastic beverage bottle, wherein the bottle is cut into two pieces above the midline. The top portion is inverted and the bottle neck rests within the inner cavity of the bottom portion. A 2 liter or 16 ounce beverage bottle may be used to create the insect trap 10.

During use, the neck 24 rests within the inner cavity of the bottom compartment 12. Once the insect is attracted by the bait 30, the insect enters the opening 22, and then goes through the neck 24 before becoming trapped within the bottom compartment 12. The neck 24 may include a closing mechanism to prevent the trapped insect from escaping the bottom compartment 12. Once the user is finished utilizing the insect trap 10 a lid 32 attached to the opening 22 of the conical funnel 20 may cover the opening 22 to trap the insects within the bottom compartment 12. Then the user may dispose of the insects or the entire trap 10 before the next use.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An insect trap comprising:
a. a bottom compartment, where the bottom compartment includes a base and a rim and the base houses a bait to attract an insect;
b. a funnel positioned above the bottom compartment, where the funnel includes an opening and a neck, where the insect flies through the opening and the neck and becomes trapped within the bottom compartment; and
c. a lid attached to the opening of the funnel, where the lid provides a means to close the opening after the insect is trapped within the bottom compartment.

2. The insect trap according to claim 1, where the funnel is conical in shape.

3. The insect trap according to claim 1, where the bottom compartment may comprise a generally circular cup shape or a squared shape.

4. The insect trap according to claim 1, where the bottom compartment is made from at least one of a plastic material and an aluminum material.

5. The insect trap according to claim 1, where the bait includes at least one of sugar water, honey, soda, sugar cubes and candy.

6. The insect trap according to claim 1, where the bait includes a pesticide as an active ingredient to kill any trapped insect.

7. The insect trap according to claim 2, where the bottom compartment and the conical funnel are made from a plastic beverage bottle, wherein the bottle is cut into two pieces above the midline to create a top portion with a bottle neck and a bottom portion.

8. The insect trap according to claim 7, where the top portion is inverted and the bottle neck rests within an inner cavity of the bottom portion.

9. The insect trap according to claim 7, where the plastic bottle is at least one of a two-liter bottle and a sixteen-ounce bottle.
